(19) United States
(12) Patent Application Publication
(10) Pub. No.: US 2025/0247325 A1
(43) Pub. Date: Jul. 31, 2025

(54) Method And System of Port Management in Network Devices

(71) Applicant: Cisco Technology, Inc., San Jose, CA (US)

(72) Inventors: Mariusz Kazmierski, Wieliczka (PL); Sunil Pareek, Karnataka (IN)

(21) Appl. No.: 18/424,560

(22) Filed: Jan. 26, 2024

(51) Int. Cl. H04L 45/12; H04L 49/253

(52) U.S. Cl. CPC H04L 45/124; H04L 49/253

(57) ABSTRACT

Devices, networks, systems, methods, and processes for managing ports of a network device in a network are described herein. The network may include multiple network devices, multiple links between the network devices, and a controller. The controller can identify one or more links switched from an active state to a blocked state. The controller may identify one or more ports of the network device that are connected to the blocked links. The controller can signal the network device to de-energize the identified ports. After the de-energization, the ports connected to the blocked links do not consume energy, thereby reducing the energy consumption of the network device. The controller can also dynamically select one or more links as critical links. The controller may maintain the critical links in the active state and also maintain one or more ports connected to the critical links in an energized state, thereby providing network resilience.

The present disclosure relates to communication networks. More particularly, the present disclosure relates to optimizing energy utilization of network devices in the communication networks.

### BACKGROUND

Communication networks are designed with redundancy to ensure high network availability, uninterrupted connectivity, and productivity in the communication networks. The redundancy is typically ensured at all levels of the communication network by way of multiple redundant devices and multiple redundant links between the devices. Addition of redundant network ports, devices, Small Form-Factor Pluggable (SFP) modules, line cards, and chassis provides alternative links within the communication network and helps to achieve the uninterrupted connectivity. However, these redundant components not only impose significant financial burdens but also increase energy consumption within the communication network. Additionally, many communication networks that include legacy devices are ill-equipped to implement energy-efficient solutions, thereby necessitating substantial upgrades and investments. The increased energy consumption in the communication network results in an adverse environmental impact, and also makes the communication network less sustainable. There are several inherent challenges that need to be overcome to develop sustainable communication networks with high network availability. One of the primary challenges lies in striking a balance between redundancy and sustainability.

As a conventional energy optimization technique, IEEE 802.3az, also known as Energy Efficient Ethernet (EEE), attempts to reduce the energy consumption during periods of low data traffic. IEEE 802.3az allows physical layer transmitters to consume less power, for instance, in one possible solution, enhancements to twisted pair cables can be used to lower the energy consumption. In another possible solution, IEEE 802.3az uses a low power idle mode to reduce the energy consumption of a link when no packets are being sent. However, even with enhanced physical layer or low-power links, all ports of all the redundant devices are operational at all times. Hence, IEEE 802.3az fails to provide any solution to reduce the energy consumption of the redundant devices.

Therefore, there is a need for an effective energy optimization technique that reduces the energy consumption of the redundant devices without affecting the network availability and connectivity.

### SUMMARY OF THE DISCLOSURE

Systems and methods for optimizing energy utilization of network devices in the communication networks in accordance with embodiments of the disclosure are described herein.

In some embodiments, a device, includes a processor, a memory communicatively coupled to the processor, and a sustainable port management logic. The logic is configured to monitor a network including a plurality of network devices and a plurality of links therebetween to determine one or more dynamic changes in the network, determine a change in a state of one or more links of the plurality of links based on the one or more dynamic changes in the network, identify one or more ports of a network device of the plurality of network devices connected to the one or more links, and generate a switching signal associated with the one or more ports of the network device.

In some embodiments, the change in the state of the one or more links includes switching the one or more links from a forwarding state to a non-forwarding state.

In some embodiments, the switching signal is indicative of de-energizing the one or more ports of the network device.

In some embodiments, the sustainable port management logic is further configured to transmit the switching signal to the network device.

In some embodiments, the network device de-energizes the one or more ports indicated by the switching signal.

In some embodiments, the sustainable port management logic is further configured to determine one or more costs of the one or more links based on at least one of one or more speeds of the one or more links, one or more types of physical mediums of the one or more links, one or more types of transceivers connected to the one or more links, one or more types of ports connected to the one or more links, or one or more types of network devices connected to the one or more links.

In some embodiments, the sustainable port management logic is further configured to identify the one or more links having higher costs.

In some embodiments, the sustainable port management logic is further configured to switch the one or more links having higher costs from the forwarding state to the non-forwarding state.

In some embodiments, the sustainable port management logic is further configured to switch one or more logical links including the one or more links in the non-forwarding state from an active state to a blocked state.

In some embodiments, the sustainable port management logic is further configured to identify a critical link of the one or more links, maintain the critical link in the forwarding state, identify a port of the one or more ports of the network device connected to the critical link, and maintain the port in an energized state when the one or more logical links are in the blocked state.

In some embodiments, the sustainable port management logic is further configured to receive control data on the critical link, modify the received control data, and forward the modified control data on the critical link.

In some embodiments, the sustainable port management logic is further configured to switch the one or more logical links from the blocked state to the active state.

In some embodiments, the sustainable port management logic is further configured to switch the one or more links in the one or more logical links from the non-forwarding state to the forwarding state.

In some embodiments, the sustainable port management logic is further configured to energize the one or more ports connected to the one or more links in the forwarding state.

In some embodiments, the sustainable port management logic is further configured to monitor data traffic on the plurality of links, identify the one or more links with no or low data traffic, and switch the one or more links with the no or low data traffic from the forwarding state to the non-forwarding state.

In some embodiments, a method includes monitoring a network including a plurality of network devices and a plurality of links therebetween to determine one or more dynamic changes in the network, determining a change in a state of one or more links of the plurality of links based on the one or more dynamic changes in the network, identifying one or more ports of a network device of the plurality of network devices connected to the one or more links, and generating a switching signal indicative of de-energizing the one or more ports of the network device.

In some embodiments, the change in the state of the one or more links includes switching the one or more links from a forwarding state to a non-forwarding state.

In some embodiments, further including transmitting the switching signal to the network device, wherein the network device de-energizes the one or more ports indicated by the switching signal.

In some embodiments, a device includes a processor, a memory communicatively coupled to the processor, and a sustainable port management logic. The logic is configured to monitor a network including a plurality of network devices and a plurality of logical links therebetween to determine one or more dynamic changes in the network, determine a change in a state of one or more logical links of the plurality of logical links based on the one or more dynamic changes in the network, identify one or more ports of a network device of the plurality of network devices coupled to the one or more logical links, generate a switching signal indicative of de-energizing the one or more ports of the network device, and transmit the switching signal to the network device.

In some embodiments, the network device de-energizes the one or more ports indicated by the switching signal.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIGS. 1A and 1B are conceptual illustrations of de-energizing one or more ports of a network device, in accordance with various embodiments of the disclosure;

FIGS. 2A and 2B are conceptual illustrations of energizing one or more ports of a network device, in accordance with various embodiments of the disclosure;

FIGS. 3A, 3B, and 3C are conceptual illustrations of selectively de-energizing one or more ports of one or more network devices, in accordance with various embodiments of the disclosure;

FIGS. 4A, 4B, and 4C are conceptual illustrations of selectively energizing one or more ports of one or more network devices, in accordance with various embodiments of the disclosure;

FIG. 5 is a conceptual network diagram of various environments that a sustainable port manager may operate on a plurality of network devices, in accordance with various embodiments of the disclosure;

FIG. 6 is a flowchart depicting a process for de-energizing one or more ports of a network device, in accordance with various embodiments of the disclosure;

FIG. 7 is a flowchart depicting a process for de-energizing one or more ports of a network device, in accordance with various embodiments of the disclosure;

FIG. 8 is a flowchart depicting a process for managing a critical link, in accordance with various embodiments of the disclosure;

FIG. 9 is a flowchart depicting a process for energizing one or more ports of a network device, in accordance with various embodiments of the disclosure;

FIG. 10 is a flowchart depicting a process for de-energizing one or more ports of a network device, in accordance with various embodiments of the disclosure; and

FIG. 11 is a conceptual block diagram of a device suitable for configuration with a sustainable port management logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that manage one or more ports of one or more network devices in a communication network. The communication network may include a plurality of network devices and a plurality of links therebetween. Each network device of the plurality of network devices can have multiple ports connected to multiple links. One or more network devices of the plurality of network devices may be redundant devices. Similarly, a few network devices of the plurality of network devices may be critical devices. One or more links of the plurality of links may be redundant links. Similarly, a few links of the plurality of links may be critical links. The communication network can further include a controller. The controller may function as a sustainable port manager for the plurality of network devices. In some embodiments, one or more network devices may function as the controller. In certain embodiments, the controller may be a separate device within the communication network or external to the communication network.

In many embodiments, the controller can monitor the communication network to determine one or more dynamic changes in the communication network. In some embodiments, the dynamic changes in the communication network may include addition of new network devices, removal of one or more existing network devices, or creation of a loop in the communication network. In certain embodiments, if there exists the loop in the communication network, multiple redundant links between same network devices may lead to broadcast storms or duplicate frames, which can cause network congestion and data inconsistency. In more embodiments, to avoid the loop, a Spanning Tree Protocol (STP) logic may select a root bridge, determine a best path from the root bridge, and switch some links into a non-forwarding state to create a loop-free network. In some more embodiments, the controller can determine when one or more links change from a forwarding state to the non-forwarding state. When the controller determines that the one or more links are switched to the non-forwarding state, the controller can identify one or more ports of a network device that are connected to the one or more links in the non-forwarding state. Thereafter, the controller may generate a switching signal associated with the identified ports of the network device. The switching signal can be indicative of de-energizing the identified ports of the network device. The controller may further transmit the switching signal to the network device. In numerous embodiments, the network device can receive the switching signal and de-energize the identified ports based on the switching signal.

In a number of embodiments, the controller may implement an enhanced STP logic. In the enhanced STP logic, the controller can determine one or more costs of the links based on at least one of: speeds of the links, types of physical mediums of the links, types of transceivers connected to the links, types of ports connected to the links, or types of network devices connected to the links. In some embodiments, the enhanced STP logic may assign lower costs to the links that are efficient and that can be selected to determine the best path to avoid the loop. In certain embodiments, the enhanced STP logic may assign higher costs to the links that are inefficient and that can be selected to be switched to the non-forwarding state. In more embodiments, the enhanced STP logic may determine a numerical value indicative of the costs of the links. In some embodiments, the links with lower speeds or lower bandwidths may have higher costs than the links with higher speeds or higher bandwidths. In certain embodiments, the links with copper cables as the physical medium may have higher costs than the links with optical fibers as the physical medium. In more embodiments, the links connected to high-power transceivers may have higher costs than the links connected to low-power transceivers. In some more embodiments, the links connected to legacy devices may have higher costs than the links connected to newer or updated devices. In numerous embodiments, the links connected to redundant ports may have higher costs than the links connected to essential ports. In many further embodiments, sustainable links may have lower costs than non-sustainable links or less sustainable links. In additional embodiments, the enhanced STP logic may determine or select the most sustainable topology for creating the loop-free network.

In numerous embodiments, the enhanced STP logic may further assess the costs of the links based on one or more enhanced classification rules. In some embodiments, for instance, one or more active network elements such as the Small Form-factor Pluggables (SFPs), linecards, physical mediums, or ports may be associated to a class. Each class may have a numerical value associated with the class for determining the costs of the links that utilize the active network elements of the class. In certain embodiments, the enhanced STP logic may determine classes A-G such that the class A is the most energy efficient and the class G is the least energy efficient. In more embodiments, for example, modern 1G linecard can be assessed to belong to class B (factor: 1000), while legacy linecards which consume more power, can belong to class F (factor: 5000). As a result, for example, the ports on the modern linecard may be more preferred to be selected by the enhanced STP logic to create the loop-free network than corresponding 1G link on the legacy linecard. In certain embodiments, for example, different linecards (such as the legacy linecards or newer/optimized linecards) in a chassis may consume different powers. In such cases, for example, the enhanced STP logic may determine the costs based on the differences in the types of the linecards. In more embodiments, for example, the enhanced STP logic may implement a chassis look at the energy consumption per line card and determine costs as per a cost range for specified bandwidth. In some more embodiments, for example, the enhanced STP logic may utilize a predefined cost range for the ports based on the bandwidth. In that, for example, the enhanced STP logic may determine the costs of the ports based on the energy consumption of the linecard, which may be available at the chassis level. In numerous embodiments, for example, if the linecard is newer, optimized and consumes less energy, then the enhanced STP logic may choose a lower cost value from the specified cost range for that 10G port, whereas a similar 10G port on the legacy linecard may be assigned higher cost value. The enhanced STP logic may also consider one or more power grid specifics (such as green energy received from one power grid or less green energy received from redundant power grid for powering the chassis or the linecard). In that case, the enhanced STP logic may mark the green powered linecard by the controller or at the chassis level and thereafter, the enhanced STP logic may implement similar process to determine the port costs.

In various embodiments, the enhanced STP logic may identify the links with higher costs. The enhanced STP logic may switch the links with higher costs into the non-forwarding state, thereby causing a dynamic change in the communication network. The controller can detect this dynamic change and can further detect the change in the state of the links having higher costs. Thereafter, the controller may identify the ports connected to the links that are switched to the non-forwarding state by the enhanced STP logic. The controller can generate the switching signal associated with the identified ports. The controller may transmit the switching signal to the network device. The network device can receive the switching signal and can further de-energize the ports that are connected to the links that are switched to the non-forwarding state by the enhanced STP logic.

In additional embodiments, multiple links may be grouped to form a logical link. In some embodiments, in an Ethernet network, multiple links or Ethernet channels may be combined to form a single logical link or an EtherChannel. In certain embodiments, the enhanced STP logic may determine costs for the EtherChannels in the Ethernet network and may block one or more EtherChannels to avoid the loop in the communication network. When the enhanced STP logic blocks a logical link, such as the EtherChannel, the controller may switch the links in the blocked logical link from the forwarding state to the non-forwarding state. Thereafter, the controller may identify the ports of the network device connected to the blocked logical link. The controller can generate the switching signal associated with the identified ports. The controller may transmit the switching signal to the network device. The network device can receive the switching signal and can further de-energize the ports that are connected to the blocked logical link.

In further embodiments, one or more links from the blocked logical link may function as critical links. In that, the critical links may be necessary to function in the forwarding state, to provide a backup for one or more essential links. In case if any essential link fails, the critical link may be used to transmit data traffic in place of the failed essential link. In some embodiments, the controller can maintain the critical links in the forwarding state. The controller may further identify one or more ports of the network device that are connected to the critical links. The controller can signal the network device to maintain the ports connected to the critical links in the energized state even when the other links in the logical link are in the non-forwarding state. In certain embodiments, the controller can generate the switching signal indicative of signaling the network device to maintain the ports connected to the critical links in the energized state and the controller can transmit the switching signal to the network device. In certain embodiments, when a critical link is in the forwarding state, the network device may transmit and/or receive control data on the critical link. The network device can process the received control data and can further forward the control data on the critical link. In more embodiments, the control data may include one or more Bridge Protocol Data Units (BPDUs) used by the STP logic or the enhanced STP logic. The network device may receive the BPDUs from other network devices, forward the BPDUs to other network devices, modify the BPDUs, or transmit the modified BPDUs to one or more network devices. In some more embodiments, the critical link may be used to transmit the switching signal to the network device. In numerous embodiments, the switching signal may be transmitted to the network device in form of the control data on a control channel over the critical link. In many further embodiments, the network device may transmit one or more BPDUs indicative of changes in the states of the links (between forwarding or non-forwarding states) or changes in the states of the ports (between energized or de-energized states). In still many embodiments, the network device may transmit the BPDUs on a single link that can be determined by a hash function applied on a BPDU frame. In still more embodiments, the controller may detect the dynamic changes in the communication network based on one or more BPDUs received from one or more network devices. Thus, maintaining the critical links in the forwarding state and the corresponding ports in the energized state may avoid breaks in the network connectivity even if any essential link fails, thereby enhancing resilience and reliability of the communication network.

In numerous embodiments, the enhanced STP logic can dynamically change the critical link in the communication network. In some embodiments, for instance, the enhanced STP logic may select a new critical link in place of a previous critical link. In that case, the controller can identify the network devices connected to the previous critical link and can signal these network devices to de-energize the ports connected to the previous critical link. Further, the controller can identify the network devices connected to the new critical link and can signal these network devices to energize the ports connected to the new critical link. In certain embodiments, the network devices may transmit one or more BPDUs indicative of changes in the critical links or changes in the states of ports or links associated with the critical links.

In many more embodiments, the enhanced STP logic may switch the logical link (such as the EtherChannel) from the blocked state to an active state, based on reconvergence or reset of the enhanced STP logic. Thereafter, the controller may switch the links in the logical link from the non-forwarding state to the forwarding state. The controller can generate the switching signal associated with the ports connected to the activated logical link. The switching signal may be indicative of energizing the ports. The network device may receive the switching signal and may further energize the ports connected to the activated logical link or the EtherChannel based on the switching signal.

In many additional embodiments, the enhanced STP logic may be used in conjunction with IEEE 802.3az or Energy Efficient Ethernet (EEE). In some embodiments, the controller can monitor data traffic on the links in the communication network. The controller can identify one or more links that have no data traffic or low data traffic. The controller can also identify the one or more links that are switched into the low-power state by IEEE 802.3az. The controller may switch the identified links from the forwarding state to the non-forwarding state. Thereafter, the controller may identify the ports of the network device connected to the links having no data traffic or low data traffic. The controller can generate the switching signal associated with the identified ports. The controller may transmit the switching signal to the network device. The network device can receive the switching signal and can further de-energize the ports that are connected to the links having no data traffic or low data traffic or the links that are switched into the low-power state by IEEE 802.3az.

In many further embodiments, the enhanced STP logic can be used for improving traffic prediction. In some embodiments, for example, if there are several Multiple Spanning Tree (MST) instances enabled on L2 EtherChannel, some of the EtherChannels may be switched to blocked state, while other L2 EtherChannels may be maintained in the forwarding state. Here, information about blocked Virtual Local Area Networks (VLANs) may be still passed to the enhanced STP logic. This information can be utilized to improve traffic prediction model and to enhance the accuracy of the traffic prediction (since it can be known that on some VLANs there will be no traffic at all, and hence, the traffic prediction can take into account only traffic in the VLANs that are in forwarding state). The enhance traffic prediction can lead to more optimal and faster decision of de-energizing particular ports or moving the data traffic for forwarded VLANs into other links.

Advantageously, the controller can reduce the energy consumption of the communication network by selectively de-energizing the ports of the network devices in the communication network to achieve the sustainability of the communication network. Further, the controller may dynamically select and maintain the critical links in the communication network to ensure the network availability, network reliability, network resiliency, and uninterrupted connectivity of the communication network. Thus, the controller achieves the balance between the network reliability and sustainability of the communication network, while reducing the costs associated with the energy consumption of the communication network.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

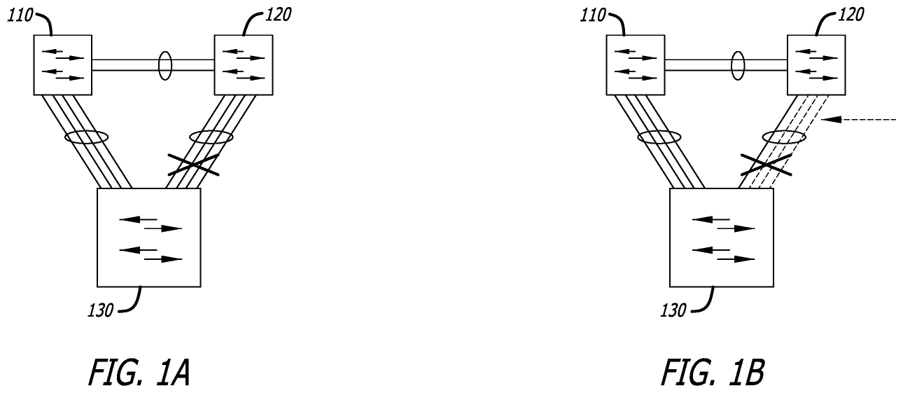

Referring to FIGS. 1A and 1B, conceptual illustrations of de-energizing one or more ports of a network device, in accordance with various embodiments of the disclosure is shown. A network 100 may include a first network device 110, a second network device 120, and a third network device 130. The first through third network devices 110-130 may be interconnected by one or more links or logical links (such as an EtherChannel).

In many embodiments, as shown in FIG. 1A, a Spanning Tree Protocol (STP) logic may block the EtherChannel between the second network device 120 and the third network device 130. Here, when the EtherChannel is blocked, the links in the EtherChannel may be in a low-power state. However, even in the low-power state, the links are active and fully functional or operational. As a result, one or more ports of the second network device 120 and the third network device 130 are also fully functional and active, and hence, consume energy. That is, blocking the EtherChannel or switching the links in the EtherChannel to the low-power states merely avoids a loop in the network 100 and does not reduce an energy consumption of the second network device 120 and the third network device 130.

In a number of embodiments, as shown in FIG. 1B, the network 100 may implement a sustainable port management logic. In some embodiments, the sustainable port management logic may be implemented by one or more of the first network device 110, the second network device 120, and the third network device 130. In certain embodiments, the sustainable port management logic can be implemented by a controller in the network 100 or external to the network 100. In more embodiments, one or more of the first network device 110, the second network device 120, and the third network device 130 may function as the controller. The controller may switch the links in the blocked EtherChannel from a forwarding state to a non-forwarding state. The controller can further signal the second network device 120 and the third network device 130 to de-energize the ports connected to the blocked EtherChannel. Since the ports are de-energized, the second network device 120 and the third network device 130 do not expend any energy on the de-energized ports, which significantly reduces the energy consumption of the second network device 120 and the third network device 130.

In various embodiments, the controller can maintain one link or one critical link from the blocked EtherChannel in the forwarding state. The critical link may be utilized by the second network device 120 and the third network device 130 to receive and/or transmit control signals or to receive and/or transmit control data on a control channel. In some embodiments, the critical link may be used to transmit and/or receive one or more Bridge Protocol Data Units (BPDUs) used by a Spanning Tree Protocol (STP) logic. The controller may further signal the second network device 120 and the third network device 130 to maintain the ports connected to the critical link in the energized state. Maintaining the critical link in the forwarding state may also help in achieving uninterrupted network connectivity and availability.

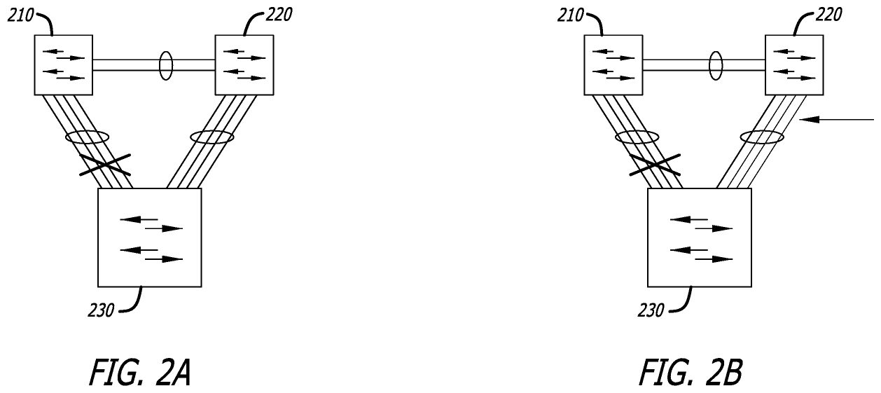

Although a specific embodiment for the network 100 for carrying out the various steps, processes, methods, and operations described herein is discussed with respect to FIG. 1, any of a variety of systems and/or processes may be utilized in accordance with embodiments of the disclosure. For example, the ports of the first through third network devices 110-130 can be dynamically energized or de-energized based on changes in the states of the links, thereby reducing the energy consumption of the first through third network devices 110-130. The elements depicted in FIG. 1 may also be interchangeable with other elements of FIGS. 2A-11 as required to realize a particularly desired embodiment.

Referring to FIGS. 2A and 2B, conceptual illustrations of energizing one or more ports of a network device, in accordance with various embodiments of the disclosure is shown. A network 200 may include a first network device 210, a second network device 220, and a third network device 230. The first through third network devices 210-230 may be interconnected by one or more links or logical links (such as EtherChannels).

In many embodiments, as shown in FIG. 2A and FIG. 2B, in case one or more essential links between the first network device 210 and the third network device 230 are cut, the STP logic may reconverge or reset. In that, the STP logic may unblock or activate the EtherChannel between the second network device 220 and the third network device 230. When the EtherChannel is unblocked, the controller may energize the ports of the second network device 220 and the third network device 230 connected to the unblocked EtherChannel. The controller may also switch the links in the EtherChannel from the non-forwarding state to the forwarding state.

Although a specific embodiment for the network 200 for carrying out the various steps, processes, methods, and operations described herein is discussed with respect to FIG. 2, any of a variety of systems and/or processes may be utilized in accordance with embodiments of the disclosure. For example, any EtherChannel can be dynamically activated or unblocked if one or more essential links in the network 200 fail, thereby maintaining network connectivity and resiliency. The elements depicted in FIG. 1 may also be interchangeable with other elements of FIGS. 1A-1B and FIGS. 3A-11 as required to realize a particularly desired embodiment.

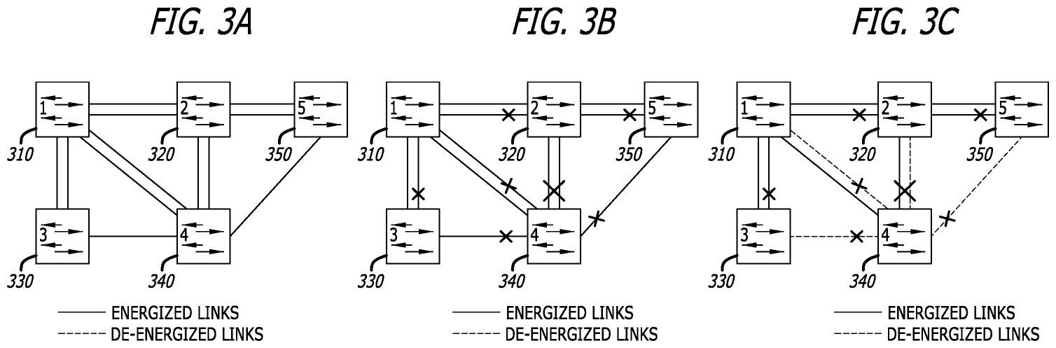

Referring to FIGS. 3A-3C, conceptual illustrations of selectively de-energizing one or more ports of one or more network devices, in accordance with various embodiments of the disclosure is shown. A network 300 may include a first network device 310, a second network device 320, a third network device 330, a fourth network device 340, and a fifth network device 350. The first through fifth network devices 310-350 may be interconnected by one or more links or logical links.

In many embodiments, as shown in FIG. 3A, there may exist one or more loops in the network 300. The loops may cause broadcast storms or duplicate frames, which can cause network congestion and data inconsistency. To avoid the loops, the STP logic may select a root bridge, determine a best path from the root bridge, and switch some links into the non-forwarding state to create a loop-free network.

In a number of embodiments, as shown in FIG. 3B, the STP logic may block one or more links or logical links, such as the EtherChannels, between the first through fifth network devices 310-350 to avoid the loop. However, the blocked links or logical links may still be operational or may operate in the low-power state. Since the links may be operational, the ports of the first through fifth network devices 310-350 connected to the links or logical links blocked by the STP may still consume energy.

In various embodiments, to reduce the energy consumption, as shown in FIG. 3C, the controller may signal the first through fifth network devices 310-350 to de-energize the ports connected to the links or the logical links blocked by the STP. The controller may switch the links or the logical links blocked by the STP from the forwarding state to the non-forwarding state. The de-energizing of the ports of the first through fifth network devices 310-350 reduces the energy consumption of the network 300.

In additional embodiments, the controller may maintain a critical link between the second network device 320 and the fourth network device 340 as shown in FIG. 3C in the forwarding state to transmit and/or receive control signals or control data between the second network device 320 and the fourth network device 340. The ports of the second network device 320 and the fourth network device 340 connected to the critical link may be maintained in the energized state even when other links or logical links are in the non-forwarding state and the other ports are de-energized.

Although a specific embodiment for the network 300 for carrying out the various steps, processes, methods, and operations described herein is discussed with respect to FIG. 3, any of a variety of systems and/or processes may be utilized in accordance with embodiments of the disclosure. For example, the EtherChannels may be blocked and the corresponding ports of the first through fifth network devices 310-350 may be de-energized accordingly to reduce the energy consumption of the network 300. The elements depicted in FIG. 3 may also be interchangeable with other elements of FIGS. 1A-2B and FIGS. 4A-11 as required to realize a particularly desired embodiment.

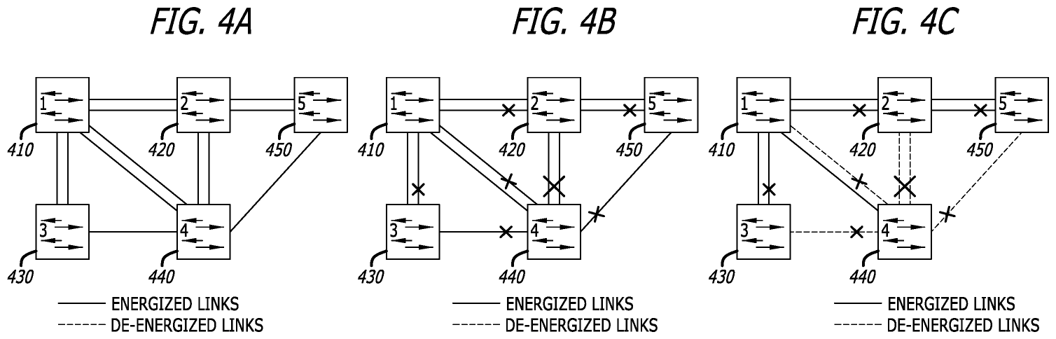

Referring to FIGS. 4A-4C, conceptual illustrations of selectively de-energizing one or more ports of one or more network devices, in accordance with various embodiments of the disclosure is shown. A network 400 may include, as shown in FIGS. 4A, 4B, and 4C, a first network device 410, a second network device 420, a third network device 430, a fourth network device 440, and a fifth network device 450. The first through fifth network devices 410-450 may be interconnected by one or more links or logical links.

In many examples, the change in the critical link is discussed below with reference to FIG. 3C and FIG. 4C. In FIG. 3C, the STP logic maintains the critical link between the second network device 320 and the fourth network device 340. In FIG. 4C, the STP logic may change the previous critical link to a new critical link between the first network device 410 and the fourth network device 440. The controller may signal the second network device 420 and the fourth network device 440 to de-energize the ports of the second network device 420 and the fourth network device 440 that were connected to the previous critical link. The controller may switch the previous critical link from the forwarding state to the non-forwarding state. Further, the controller can switch the new critical link from the non-forwarding state to the forwarding state. The controller can energize the ports of the first network device 410 and the fourth network device 440 connected to the new critical link to transmit and/or receive the control signals or the control data on the control channel, thereby maintaining connectivity and network redundancy in the network 400.

Although a specific embodiment for the network 400 for carrying out the various steps, processes, methods, and operations described herein is discussed with respect to FIG. 4, any of a variety of systems and/or processes may be utilized in accordance with embodiments of the disclosure. For example, the STP logic may dynamically select or change the critical links based on the dynamic changes in the network 400 and the controller may de-energize or energize one or more ports of the one or more network devices accordingly. The elements depicted in FIG. 4 may also be interchangeable with other elements of FIGS. 1A-3C and FIGS. 5-11 as required to realize a particularly desired embodiment.

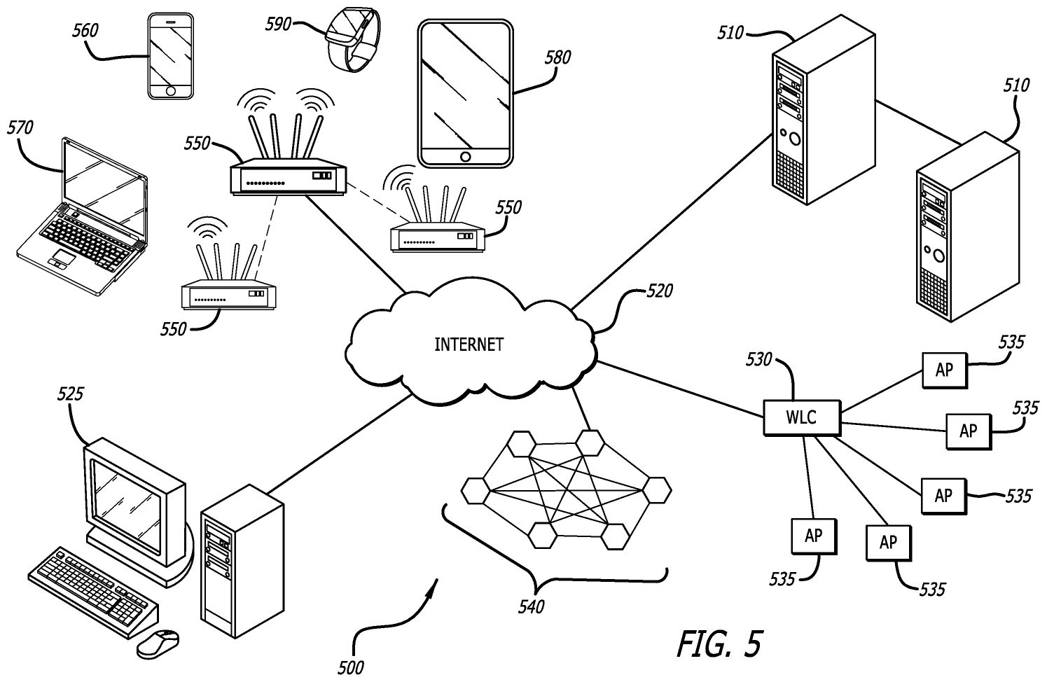

Referring to FIG. 5, a conceptual network 500 diagram of various environments that a sustainable port manager may operate on a plurality of network devices, in accordance with various embodiments of the disclosure is shown. Those skilled in the art will recognize that the sustainable port manager can be comprised of various hardware and/or software deployments and can be configured in a variety of ways. In many embodiments, the sustainable port manager can be configured as a standalone device, exist as a logic in another network device, be distributed among various network devices operating in tandem, or remotely operated as part of a cloud-based network management tool. In further embodiments, one or more servers 510 can be configured with or otherwise operate the sustainable port manager. In many embodiments, the sustainable port manager may operate on one or more servers 510 connected to a communication network or internet 520. The communication network or internet 520 can include wired networks or wireless networks. The sustainable port manager can be provided as a cloud-based service that can service remote networks, such as, but not limited to a deployed network 540. In many embodiments, the sustainable port manager can be a logic that reduces the energy consumption of the network 500.

However, in additional embodiments, the sustainable port manager may be operated as a distributed logic across multiple network devices. In the embodiment depicted in FIG. 5, a plurality of network access points (APs) 550 can operate as the sustainable port manager in a distributed manner or may have one specific device operate as sustainable port manager for all of the neighboring or sibling APs 550. The APs 550 facilitate Wi-Fi connections for various electronic devices, such as but not limited to mobile computing devices including laptop computers 570, cellular phones 560, portable tablet computers 580 and wearable computing devices 590.

In further embodiments, the sustainable port manager may be integrated within another network device. In the embodiment depicted in FIG. 5, a wireless LAN controller (WLC) 530 may have a sustainable port manager that the WLC 530 can use to optimize the energy consumption of the various APs 535 that the WLC 530 is connected to, either wired or wirelessly. In still more embodiments, a personal computer 525 may be utilized to access and/or manage various aspects of the sustainable port manager, either remotely or within the network itself. In the embodiment depicted in FIG. 5, the personal computer 525 communicates over the communication network or internet 520 and can access the sustainable port manager of the servers 510, or the network APs 550, or the WLC 530.

Although a specific embodiment for various environments that the sustainable port manager may operate on a plurality of network devices suitable for carrying out the various steps, processes, methods, and operations described herein is discussed with respect to FIG. 5, any of a variety of systems and/or processes may be utilized in accordance with embodiments of the disclosure. In many non-limiting examples, the sustainable port manager may be provided as a device or software separate from the network devices or the sustainable port manager may be integrated into one or more network devices. The elements depicted in FIG. 5 may also be interchangeable with other elements of FIGS. A1-4C and 6-11 as required to realize a particularly desired embodiment.

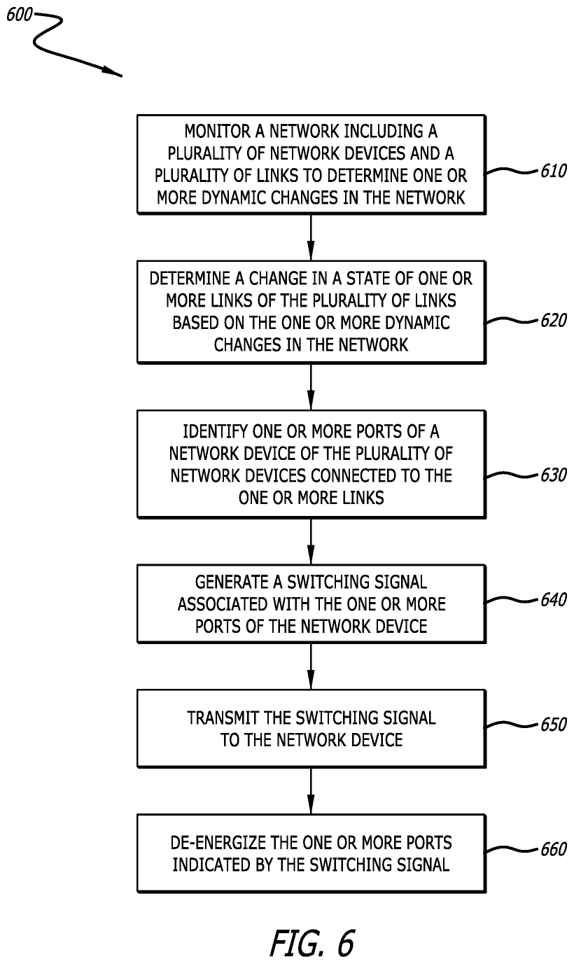

Referring to FIG. 6, a flowchart depicting a process 600 for de-energizing one or more ports of the network device, in accordance with various embodiments of the disclosure is shown. In many embodiments, the process 600 can monitor a network including a plurality of network devices and a plurality of links between the plurality of network devices to determine one or more dynamic changes in the network (block 610). In some embodiments, each network device of the plurality of network devices can have multiple ports connected to multiple links. In certain embodiments, one or more network devices of the plurality of network devices may be redundant devices. In more embodiments, similarly, a few network devices of the plurality of network devices may be critical devices. In some more embodiments, one or more links of the plurality of links may be redundant links. In numerous embodiments, similarly, a few links of the plurality of links may be critical links. In many further embodiments, the process 600 may be implemented by a controller or by a sustainable port manager or by one or more network devices in the network. In many more embodiments, the controller or the sustainable port manager may be in the network or external to the network. In additional embodiments, the process 600 can detect the dynamic changes in the network based on one or more BPDUs received from one or more network devices.

In a number of embodiments, the process 600 may determine a change in a state of one or more links of the plurality of links based on the one or more dynamic changes in the network (block 620). In some embodiments, the dynamic changes in the network may include addition of new network devices, removal of one or more existing network devices, or creation of a loop in the network. In certain embodiments, if there exists the loop in the network, multiple redundant links between same devices may lead to broadcast storms or duplicate frames, which can cause network congestion and data inconsistency. In more embodiments, to avoid the loop, the STP logic may select a root bridge, determine a best path from the root bridge, and switch some links into the non-forwarding state to create a loop-free network. In some more embodiments, the process 600 can detect the dynamic changes associated with the switching of the states of the links by the STP logic.

In various embodiments, the process 600 can identify one or more ports of the network device of the plurality of network devices connected to the one or more links (block 630). In some embodiments, when the process 600 determines that the one or more links are switched to the non-forwarding state, the process 600 can identify one or more ports of the network device that are connected to the one or more links in the non-forwarding state. In certain embodiments, the process 600 may identify one or more redundant ports of the network device that are connected to the links in the non-forwarding state.

In additional embodiments, the process 600 may generate a switching signal associated with the one or more ports of the network device (block 640). In some embodiments, the switching signal can be indicative of de-energizing the identified ports of the network device. In certain embodiments, the switching signal can be a control signal transmitted to the network device. In more embodiments, the process 600 may generate the switching signal in form of control data that is transmitted to the network device on the control channel.

In further embodiments, the process 600 can transmit the switching signal to the network device (block 650). In some embodiments, the process 600 can transmit the switching signal to an intermediate network device which can forward the switching signal to the network device connected to the links that are in the non-forwarding state. In certain embodiments, the process 600 may transmit the switching signal over the links or the logical link (such as the EtherChannel) connected to the network device.

In many more embodiments, the process 600 can signal the network device to de-energize the ports indicated by the switching signal (block 660). In some embodiments, the network device can receive the switching signal and de-energize the identified ports based on the switching signal. In certain embodiments, the de-energized ports do not consume energy, thereby reducing the energy consumption of the network device. In more embodiments, the process 600 may transmit another switching signal to the network device to energize the de-energized ports after the STP logic reconverges or resets.

Although a specific embodiment for the process 600 to de-energize one or more ports of the network device is described above with respect to FIG. 6, any of a variety of systems and/or processes may be utilized in accordance with embodiments of the disclosure. For example, the process 600 may dynamically signal the network device to de-energize or energize the ports based on STP convergence or STP reconvergence or reset. The aspects described in FIG. 6 may also be interchangeable with other elements of FIGS. 1A-5 and FIGS. 7-11 as required to realize a particularly desired embodiment.

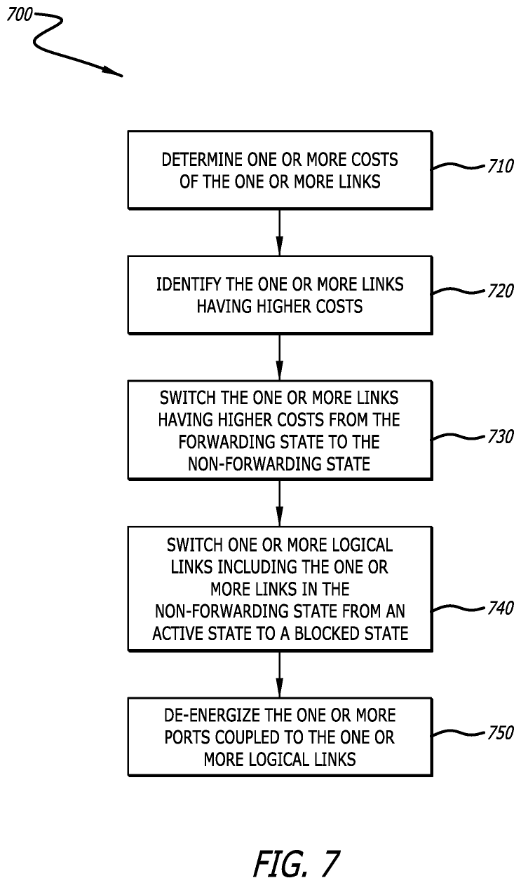

Referring to FIG. 7, a flowchart depicting a process 700 for de-energizing one or more ports of the network device, in accordance with various embodiments of the disclosure is shown. In many embodiments, the process 700 can determine one or more costs of the one or more links (block 710). In some embodiments, the process 700 may implement an enhanced STP logic in the network. In certain embodiments, the process 700 can include one or more parameters of the links, the logical links (such as the EtherChannels), or the network devices to determine the costs of the links. In more embodiments, the process 700 may determine the costs of the links based at least one of: speeds of the links, types of physical mediums of the links, types of transceivers connected to the links, types of ports connected to the links, or types of network devices connected to the links.

In a number of embodiments, the process 700 may identify the one or more links having higher costs (block 720). In some embodiments, the process 700 may assign lower costs to the links that are efficient and that can be selected to determine the best path to avoid the loop. In certain embodiments, the process 700 may assign higher costs to the links that are inefficient and that can be selected to be switched to the non-forwarding state. In more embodiments, the process 700 may determine a numerical value indicative of the costs of the links. In some embodiments, the links with lower speeds or lower bandwidths may have higher costs than the links with higher speeds or higher bandwidths. In certain embodiments, the links with copper cables as the physical medium may have higher costs than the links with optical fibers as the physical medium. In more embodiments, the links connected to high-power transceivers may have higher costs than the links connected to low-power transceivers. In some more embodiments, the links connected to legacy devices may have higher costs than the links connected to newer or updated devices. In numerous embodiments, the links connected to redundant ports may have higher costs than the links connected to essential ports. In many further embodiments, sustainable links may have lower costs than non-sustainable links or less sustainable links. In additional embodiments, the enhanced STP logic may determine or select the most sustainable topology for creating the loop-free network.

In numerous embodiments, the enhanced STP logic may further assess the costs of the links based on one or more enhanced classification rules. In some embodiments, for instance, one or more active network elements such as the Small Form-factor Pluggables (SFPs), linecards, physical mediums, or ports may be associated to a class. Each class may have a numerical value associated with the class for determining the costs of the links that utilize the active network elements of the class. In certain embodiments, the enhanced STP logic may determine classes A-G such that the class A is the most energy efficient and the class G is the least energy efficient. In more embodiments, for example, modern 1G linecard can be assessed to belong to class B (factor: 1000), while legacy linecards which consume more power, can belong to class F (factor: 5000). As a result, for example, the ports on the modern linecard may be more preferred to be selected by the enhanced STP logic to create the loop-free network than corresponding 1G link on the legacy linecard. In certain embodiments, for example, different linecards (such as the legacy linecards or newer/optimized linecards) in a chassis may consume different powers. In such cases, for example, the enhanced STP logic may determine the costs based on the differences in the types of the linecards. In more embodiments, for example, the enhanced STP logic may implement a chassis look at the energy consumption per line card and determine costs as per a cost range for specified bandwidth. In some more embodiments, for example, the enhanced STP logic may utilize a predefined cost range for the ports based on the bandwidth. In that, for example, the enhanced STP logic may determine the costs of the ports based on the energy consumption of the linecard, which may be available at the chassis level. In numerous embodiments, for example, if the linecard is newer, optimized and consumes less energy, then the enhanced STP logic may choose a lower cost value from the specified cost range for that 10G port, whereas a similar 10G port on the legacy linecard may be assigned higher cost value. The enhanced STP logic may also consider one or more power grid specifics (such as green energy received from one power grid or less green energy received from redundant power grid for powering the chassis or the linecard). In that case, the enhanced STP logic may mark the green powered linecard by the controller or at the chassis level and thereafter, the enhanced STP logic may implement similar process to determine the port costs.

In various embodiments, the process 700 can switch the one or more links having higher costs from the forwarding state to the non-forwarding state (block 730). In some embodiments, the process 700 may cause the dynamic change in the network by switching the links from the forwarding state to the non-forwarding state. In certain embodiments, the network devices may transmit one or more BPDUs indicative of changes in the states of the links (between forwarding or non-forwarding states) or changes in the states of the ports (between energized or de-energized states). In more embodiments, the controller can detect this dynamic change in the network caused by the process 700 based on the one or more BPDUs.

In additional embodiments, the process 700 may switch one or more logical links including the one or more links in the non-forwarding state from the active state to the blocked state (block 740). In some embodiments, the links determined by the enhanced STP logic or the process 700 may be combined to form the logical links such as the EtherChannels. In certain embodiments, the process 700 may block the EtherChannels based on the enhanced STP logic.

In further embodiments, the process 700 can de-energize the one or more ports coupled to the one or more logical links (block 750). In some embodiments, the process 700 can generate the switching signal associated with the ports. In certain embodiments, the process 700 may transmit the switching signal to the network device. In more embodiments, the network device can receive the switching signal and can further de-energize the ports that are connected to the blocked logical links, such as the EtherChannels, or the links that are switched to the non-forwarding state by the enhanced STP logic.

Although a specific embodiment for the process 700 to de-energize one or more ports of the network device is described above with respect to FIG. 7, any of a variety of systems and/or processes may be utilized in accordance with embodiments of the disclosure. For example, the enhanced STP logic may dynamically determine the costs of the EtherChannels and block the EtherChannels with higher costs. The aspects described in FIG. 7 may also be interchangeable with other elements of FIGS. 1A-6 and FIGS. 8-11 as required to realize a particularly desired embodiment.

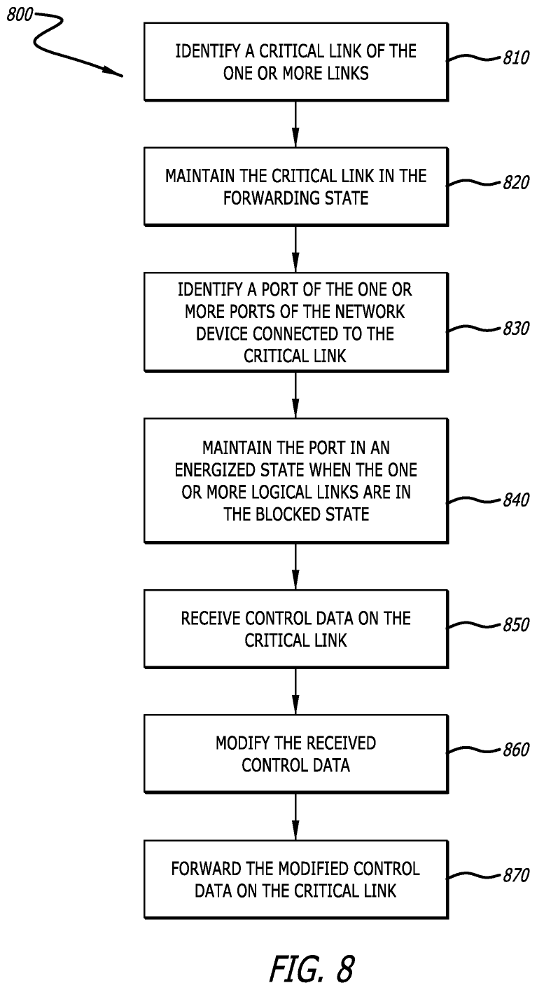

Referring to FIG. 8, a flowchart depicting a process 800 for managing the critical link, in accordance with various embodiments of the disclosure is shown. In many embodiments, the process 800 can identify the critical link of the one or more links (block 810). In some embodiments, one or more links from the blocked logical link may function as the critical links. In certain embodiments, the critical links may be necessary to function in the forwarding state, to provide a backup for one or more essential links. In more embodiments, if any essential link fails, the critical link may be used to transmit data traffic in place of the failed essential link to maintain the network connectivity.

In a number of embodiments, the process 800 may maintain the critical link in the forwarding state (block 820). In some embodiments, the critical link may be dynamically selected by the enhanced STP logic. In certain embodiments, the enhanced STP logic may dynamically change the previous critical link to a new critical link based on the dynamic changes in the network. In more embodiments, when the enhanced STP logic changes the critical link, the new critical link may be maintained in the forwarding state and the previous critical link may be switched to the non-forwarding state.

In various embodiments, the process 800 can identify the ports of the one or more ports of the network devices connected to the critical link (block 830). In some embodiments, when the enhanced STP logic changes the critical link, the process 800 can identify the ports of the network devices connected to the new critical link. In certain embodiments, the new critical link can be between different network devices separate from the network devices connected to the previous critical link.

In additional embodiments, the process 800 may maintain the ports in the energized state when the one or more logical links are in the blocked state (block 840). In some embodiments, the process 800 can generate the switching signal indicative of signaling the network device to maintain the ports connected to the new critical link in the energized state. In certain embodiments, the process 800 can receive the switching signal, de-energize the ports connected to the previous critical link, and then energize the ports connected to the new critical link. In more embodiments, the ports of the network device connected to the critical link are maintained in the energized state even when the other ports connected to the logical link that includes the critical link are de-energized. In some more embodiments, for instance, the network device always maintains the ports connected to the critical links in the energized state, irrespective of the state of the other ports of the network device.

In further embodiments, the process 800 can receive control data on the critical link (block 850). In some embodiments, the network device can receive one or more control signals on the critical link. In certain embodiments, the network device can receive data traffic on the critical link and can forward the data traffic to another network device. In more embodiments, the control data may be associated with the operational state of the network device. In some more embodiments, the control data may include the BPDUs used by the STP logic or the enhanced STP logic. In numerous embodiments, the process 800 may receive the BPDUs from other network devices and may further forward the BPDUs to other network devices. In many further embodiments, process 800 may receive the switching signal on the critical link. In still more embodiments, the switching signal may be transmitted to the network device in form of the control data on the control channel over the critical link.

In many more embodiments, the process 800 may modify the received control data (block 860). In some embodiments, the network device may change an operational state based on the control data. In certain embodiments, the network device may forward the modified control data to another network device. In more embodiments, the process 800 may exchange the BPDUs with the other network devices. In some more embodiments, the process 800 can modify the BPDUs and can further transmit the modified BPDUs to one or more network devices. In numerous embodiments, the process 800 can transmit one or more BPDUs indicative of changes in the states of the links (between forwarding or non-forwarding states) or changes in the states of the ports (between energized or de-energized states). In still many embodiments, the process 800 may transmit the BPDUs on a single link that can be determined by a hash function applied on a BPDU frame.

In many additional embodiments, the process 800 can forward the modified control data on the critical link (block 870). In some embodiments, the modified control data may be indicative of switching the operational state of the network device. In certain embodiments, the process 800 may transmit the modified control data in form of the control signal or an acknowledgement signal on the critical link. In more embodiments, the process 800 may transmit modified BPDUs indicative of changes in the state of the links or the critical links connected to the network device.

Although a specific embodiment for the process 800 to manage the critical link is described above with respect to FIG. 8, any of a variety of systems and/or processes may be utilized in accordance with embodiments of the disclosure. For example, the process 800 may dynamically select or change the critical links. The aspects described in FIG. 8 may also be interchangeable with other elements of FIGS. 1A-7 and FIGS. 9-11 as required to realize a particularly desired embodiment.

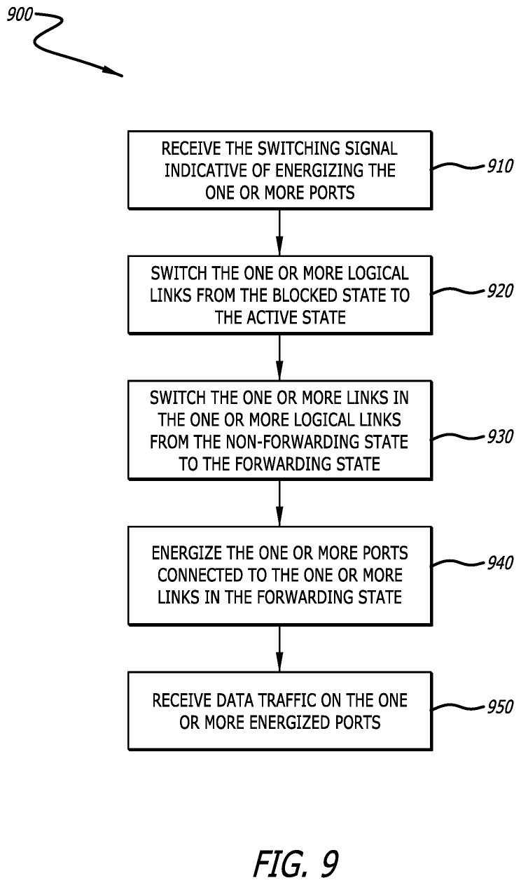

Referring to FIG. 9, a flowchart depicting a process 900 for energizing one or more ports of the network device, in accordance with various embodiments of the disclosure is shown. In some embodiments, the process 900 can receive the switching signal indicative of energizing the one or more ports (block 910). In some embodiments, the switching signal may be associated with the ports of the network device that are connected to the unblocked EtherChannel. In certain embodiments, the unblocked EtherChannel may include one or more links connected to the network device that were previously in the non-forwarding state.

In a number of embodiments, the process 900 may switch the one or more logical links from the blocked state to the active state (block 920). In some embodiments, the enhanced STP logic or the STP logic may reconverge or reset and may select the logical links (such as the EtherChannels) that must be activated or unblocked. In certain embodiments, the STP reset or reconvergence may be triggered by the dynamic changes in the network. In more embodiments, the non-forwarding links in the unblocked EtherChannels may be switched into the forwarding state after the STP reconvergence or reset.

In various embodiments, the process 900 can switch the one or more links in the one or more logical links from the non-forwarding state to the forwarding state (block 930). In some embodiments, if the STP reconverges or resets, it may be necessary to switch the links to the forwarding state to ensure uninterrupted connectivity in the network. In certain embodiments, the network device may exchange BPDUs or modified BPDUs with the other network devices indicative of the change in the state of the links or the state of the EtherChannel.

In additional embodiments, the process 900 may energize the one or more ports connected to the one or more links in the forwarding state (block 940). In some embodiments, the process 900 can transmit the switching signal to the network device. In certain embodiments, the network device may energize the ports based on the switching signal. In more embodiments, the switching signal may be sent along with the BPDUs or in form of a BPDU.

In further embodiments, the process 900 can receive data traffic on the one or more energized ports (block 950). In some embodiments, the network device can forward the received data traffic to another network device. In some more embodiments, the network device may store or process the received data traffic.

Although a specific embodiment for the process 900 to energize one or more ports of the network device is described above with respect to FIG. 9, any of a variety of systems and/or processes may be utilized in accordance with embodiments of the disclosure. For example, the process 900 may dynamically energize the ports of the network device when the STP logic or the enhanced STP logic reconverges or resets. The aspects described in FIG. 9 may also be interchangeable with other elements of FIGS. 1A-8 and FIGS. 10-11 as required to realize a particularly desired embodiment.

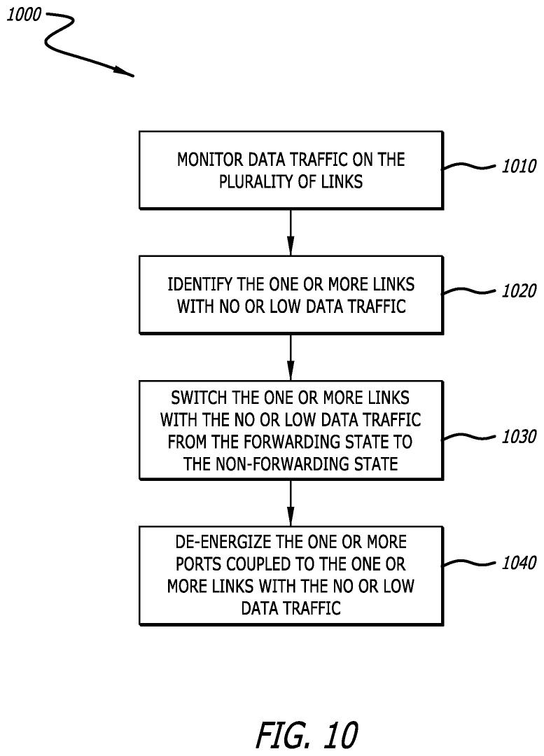

Referring to FIG. 10, a flowchart depicting a process 1000 for de-energizing one or more ports of the network device, in accordance with various embodiments of the disclosure is shown. In many embodiments, the process 1000 can monitor the data traffic on the plurality of links (block 1010). In some embodiments, the process 1000 may identify the links with high data traffic and the links with low data traffic. In some more embodiments, the process 1000 can be implemented in conjunction with IEEE 802.3az.

In a number of embodiments, the process 1000 may identify the one or more links having no data traffic or low data traffic (block 1020). In some embodiments, the process 1000 can utilize one or more network management softwares to analyze a flow of data traffic on the links. In certain embodiments, the process 1000 may collect information about the data traffic on the links by utilizing Simple Network Management Protocol (SNMP). In more embodiments, the network device may monitor the ports to identify an amount of data traffic on the links connected to the ports.

In various embodiments, the process 1000 can switch the one or more links having no data traffic or low data traffic from the forwarding state to the non-forwarding state (block 1030). In some embodiments, the process 1000 may utilize the low-power links identified by IEEE 802.3az. In certain embodiments, the process 1000 can switch the low-power links to the non-forwarding state based on IEEE 802.3az.

In additional embodiments, the process 1000 may de-energize the one or more ports coupled to the one or more links having no data traffic or low data traffic (block 1040). In some embodiments, de-energizing the ports may reduce the energy consumption of the network device. In certain embodiments, the process 1000 may transmit one or more BPDUs indicative of the change in the state of the ports of the network device.

In many further embodiments, the process 1000 may utilize the enhanced STP logic for improving traffic prediction. In some embodiments, for example, if there are several Multiple Spanning Tree (MST) instances enabled on L2 EtherChannel, some of the EtherChannels may be switched to blocked state, while other L2 EtherChannels may be maintained in the forwarding state. Here, information about blocked Virtual Local Area Networks (VLANs) may be still passed to the enhanced STP logic. This information can be utilized to improve traffic prediction model and to enhance the accuracy of the traffic prediction (since it can be known that on some VLANs there will be no traffic at all, and hence, the traffic prediction can take into account only traffic in the VLANs that are in forwarding state). The enhance traffic prediction can lead to more optimal and faster decision of de-energizing particular ports or moving the data traffic for forwarded VLANs into other links.

Although a specific embodiment for the process 1000 to de-energize one or more ports of the network device is described above with respect to FIG. 10, any of a variety of systems and/or processes may be utilized in accordance with embodiments of the disclosure. For example, the process 1000 may dynamically de-energize the ports of the network device in conjunction with IEEE 802.3az. The aspects described in FIG. 9 may also be interchangeable with other elements of FIGS. 1A-9 and FIG. 11 as required to realize a particularly desired embodiment.

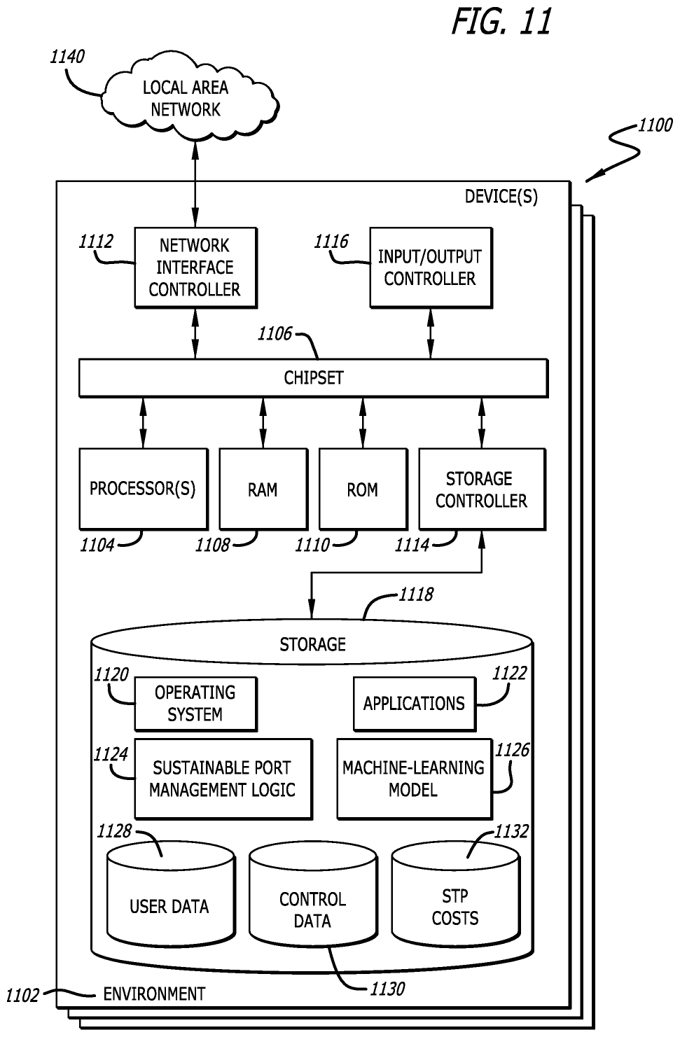

Referring to FIG. 11, a conceptual block diagram of a device 1100 suitable for configuration with a sustainable port management logic, in accordance with various embodiments of the disclosure is shown. The embodiment of the conceptual block diagram depicted in FIG. 11 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 11 can also illustrate an access point, a switch, or a router in accordance with various embodiments of the disclosure. The device 1100 may, in many non-limiting examples, correspond to physical devices or to virtual resources described herein.

In many embodiments, the device 1100 may include an environment 1102 such as a baseboard or “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In more embodiments, one or more processors 1104, such as, but not limited to, central processing units (“CPUs”) can be configured to operate in conjunction with a chipset 1106. The processor(s) 1104 can be standard programmable CPUs that perform arithmetic and logical operations necessary for the operation of the device 1100.

In a number of embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1106 may provide an interface between the processor(s) 1104 and the remainder of the components and devices within the environment 1102. The chipset 1106 can provide an interface to a random-access memory (“RAM”) 1108, which can be used as the main memory in the device 1100 in some embodiments. The chipset 1106 can further be configured to provide an interface to a computer-readable storage medium such as a read-only memory (“ROM”) 1110 or non-volatile RAM (“NVRAM”) for storing basic routines that can help with various tasks such as, but not limited to, starting up the device 1100 and/or transferring information between the various components and devices. The ROM 1110 or NVRAM can also store other application components necessary for the operation of the device 1100 in accordance with various embodiments described herein.

Additional embodiments of the device 1100 can be configured to operate in a networked environment using logical connections to remote computing devices and computer systems through a network, such as the network 1140. The chipset 1106 can include functionality for providing network connectivity through a network interface card (“NIC”) 1112, which may comprise a gigabit Ethernet adapter or similar component. The NIC 1112 can be capable of connecting the device 1100 to other devices over the network 1140. It is contemplated that multiple NICs 1112 may be present in the device 1100, connecting the device to other types of networks and remote systems.

In further embodiments, the device 1100 can be connected to a storage 1118 that provides non-volatile storage for data accessible by the device 1100. The storage 1118 can, for instance, store an operating system 1120, applications 1122, user data 1128, control data 1130, and STP costs 1132 which are described in greater detail below. The storage 1118 can be connected to the environment 1102 through a storage controller 1114 connected to the chipset 1106. In certain embodiments, the storage 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The user data 1128 may be received by the device 1100 through the data traffic on one or more ports of the device 1100. The control data 1130 may include the BPDUs exchanged by or with the device 1100. The STP costs 1132 may be numerical values indicative of the costs of the links connected to the ports of the device 1100 based on the enhanced STP logic.

The device 1100 can store data within the storage 1118 by transforming the physical state of the physical storage units to reflect the information being stored. The specific transformation of physical state can depend on various factors. Examples of such factors can include, but are not limited to, the technology used to implement the physical storage units, whether the storage 1118 is characterized as primary or secondary storage, and the like.

In many more embodiments, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1100 can further read or access information from the storage 1118 by detecting the physical states or characteristics of one or more particular locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, the operations performed by a cloud computing network, and or any components included therein, may be supported by one or more devices similar to device 1100. Stated otherwise, some or all of the operations performed by the cloud computing network, and or any components included therein, may be performed by one or more devices 1100 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1118 can store an operating system 1120 utilized to control the operation of the device 1100. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1118 can store other system or application programs and data utilized by the device 1100.

In many additional embodiments, the storage 1118 or other computer-readable storage media is encoded with computer-executable instructions which, when loaded into the device 1100, may transform it from a general-purpose computing system into a special-purpose computer capable of implementing the embodiments described herein. These computer-executable instructions may be stored as application 1122 and transform the device 1100 by specifying how the processor(s) 1104 can transition between states, as described above. In some embodiments, the device 1100 has access to computer-readable storage media storing computer-executable instructions which, when executed by the device 1100, perform the various processes described above with regard to FIGS. 1-10. In certain embodiments, the device 1100 can also include computer-readable storage media having instructions stored thereupon for performing any of the other computer-implemented operations described herein.

In many further embodiments, the device 1100 may include a sustainable port management logic 1124. The sustainable port management logic 1124 can be configured to perform one or more of the various steps, processes, operations, and/or other methods that are described above. Often, the sustainable port management logic 1124 can be a set of instructions stored within a non-volatile memory that, when executed by the processor(s)/controller(s) 1104 can carry out these steps, etc. In some embodiments, the sustainable port management logic 1124 may be a client application that resides on a network-connected device, such as, but not limited to, a server, switch, personal or mobile computing device in a single or distributed arrangement. In certain embodiments, the sustainable port management logic 1124 reduces the energy consumption of the device 1100 by de-energizing one or more ports of the device 1100.

In still further embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 might not include all of the components shown in FIG. 11 and can include other components that are not explicitly shown in FIG. 11 or might utilize an architecture completely different than that shown in FIG. 11.

As described above, the device 1100 may support a virtualization layer, such as one or more virtual resources executing on the device 1100. In some examples, the virtualization layer may be supported by a hypervisor that provides one or more virtual machines running on the device 1100 to perform functions described herein. The virtualization layer may generally support a virtual resource that performs at least a portion of the techniques described herein.

Finally, in numerous additional embodiments, data may be processed into a format usable by a machine-learning model 1126 (e.g., feature vectors), and or other pre-processing techniques. The machine-learning (“ML”) model 1126 may be any type of ML model, such as supervised models, reinforcement models, and/or unsupervised models. The ML model 1126 may include one or more of linear regression models, logistic regression models, decision trees, Naïve Bayes models, neural networks, k-means cluster models, random forest models, and/or other types of ML models 1126.

The ML model(s) 1126 can be configured to generate inferences to make predictions or draw conclusions from data. An inference can be considered the output of a process of applying a model to new data. This can occur by learning from at least the user data 1128, the control data 1130, and the STP costs 1132 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1126 may be generated by human/administrator verifications or may compare predicted outcomes with actual outcomes.

Although a specific embodiment for a device suitable for configuration with a network optimization logic for carrying out the various steps, processes, methods, and operations described herein is discussed with respect to FIG. 11, any of a variety of systems and/or processes may be utilized in accordance with embodiments of the disclosure. For example, the device 1100 may be in a virtual environment such as a cloud-based network administration suite, or it may be distributed across a variety of network devices or switches. The elements depicted in FIG. 11 may also be interchangeable with other elements of FIGS. 1A-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a sustainable port management logic, configured to:
monitor a network including a plurality of network devices and a plurality of links therebetween to determine one or more dynamic changes in the network;
determine a change in a state of one or more links of the plurality of links based on the one or more dynamic changes in the network;
identify one or more ports of a network device of the plurality of network devices connected to the one or more links; and
generate a switching signal associated with the one or more ports of the network device.

2. The device of claim 1, wherein the change in the state of the one or more links includes switching the one or more links from a forwarding state to a non-forwarding state.

3. The device of claim 2, wherein the switching signal is indicative of de-energizing the one or more ports of the network device.

4. The device of claim 3, wherein the sustainable port management logic is further configured to transmit the switching signal to the network device.

5. The device of claim 4, wherein the network device de-energizes the one or more ports indicated by the switching signal.

6. The device of claim 2, wherein the sustainable port management logic is further configured to determine one or more costs of the one or more links based on at least one of:
one or more speeds of the one or more links,
one or more types of physical mediums of the one or more links,
one or more types of transceivers connected to the one or more links,
one or more types of ports connected to the one or more links, or
one or more types of network devices connected to the one or more links.

7. The device of claim 6, wherein the sustainable port management logic is further configured to identify the one or more links having higher costs.

8. The device of claim 7, wherein the sustainable port management logic is further configured to switch the one or more links having higher costs from the forwarding state to the non-forwarding state.

9. The device of claim 2, wherein the sustainable port management logic is further configured to switch one or more logical links including the one or more links in the non-forwarding state from an active state to a blocked state.

10. The device of claim 9, wherein the sustainable port management logic is further configured to:
identify a critical link of the one or more links;
maintain the critical link in the forwarding state;
identify a port of the one or more ports of the network device connected to the critical link; and
maintain the port in an energized state when the one or more logical links are in the blocked state.

11. The device of claim 10, wherein the sustainable port management logic is further configured to:
receive control data on the critical link;
modify the received control data; and
forward the modified control data on the critical link.

12. The device of claim 9, wherein the sustainable port management logic is further configured to switch the one or more logical links from the blocked state to the active state.

13. The device of claim 12, wherein the sustainable port management logic is further configured to switch the one or more links in the one or more logical links from the non-forwarding state to the forwarding state.

14. The device of claim 13, wherein the sustainable port management logic is further configured to energize the one or more ports connected to the one or more links in the forwarding state.

15. The device of claim 2, wherein the sustainable port management logic is further configured to:
monitor data traffic on the plurality of links;
identify the one or more links with no or low data traffic; and
switch the one or more links with the no or low data traffic from the forwarding state to the non-forwarding state.

16. A method, comprising:
monitoring a network including a plurality of network devices and a plurality of links therebetween to determine one or more dynamic changes in the network;
determining a change in a state of one or more links of the plurality of links based on the one or more dynamic changes in the network;
identifying one or more ports of a network device of the plurality of network devices connected to the one or more links; and
generating a switching signal indicative of de-energizing the one or more ports of the network device.

17. The method of claim 16, the change in the state of the one or more links includes switching the one or more links from a forwarding state to a non-forwarding state.

18. The method of claim 17, further comprising transmitting the switching signal to the network device, wherein the network device de-energizes the one or more ports indicated by the switching signal.

19. A device, comprising:
a processor;
a memory communicatively coupled to the processor; and
a sustainable port management logic, configured to:
monitor a network including a plurality of network devices and a plurality of logical links therebetween to determine one or more dynamic changes in the network;
determine a change in a state of one or more logical links of the plurality of logical links based on the one or more dynamic changes in the network;
identify one or more ports of a network device of the plurality of network devices coupled to the one or more logical links;
generate a switching signal indicative of de-energizing the one or more ports of the network device; and
transmit the switching signal to the network device.

20. The device of claim 19, wherein the network device de-energizes the one or more ports indicated by the switching signal.
